(19) United States
(12) Patent Application Publication
(10) Pub. No.: US 2010/0274480 A1
(43) Pub. Date: Oct. 28, 2010

(54) GESTURE ACTUATED POINT OF INTEREST INFORMATION SYSTEMS AND METHODS

(75) Inventors: CLARK E. MCCALL, ANN ARBOR, MI (US); WILLIAM A. BIONDO, BEVERLY HILLS, MI (US); DAVID T. PROEFKE, MADISON HEIGHTS, MI (US)

Correspondence Address: INGRASSIA FISHER & LORENZ, P.C. (GM), 7010 E. COCHISE ROAD, SCOTTSDALE, AZ, 85253, US

(73) Assignee: GM GLOBAL TECHNOLOGY OPERATIONS, INC., DETROIT, MI (US)

(21) Appl. No.: 12/430,389

(22) Filed: Apr. 27, 2009

(51) Int. Cl. G01C 21/00; G06F 3/033; G06F 17/30; G06F 7/00

(52) U.S. Cl. 701/207; 715/863; 707/E17.044; 707/E17.018

(57) ABSTRACT

An information system for providing point of interest information to a user in a vehicle is provided. The system includes a gesture capture device configured to capture data associated with a user gesture, the user gesture having a direction indicating a desired point of interest. The system further includes a navigation device configured to provide a location and orientation associated with the vehicle and a processing module coupled to the gesture capture device and the navigation device. The processing module is configured to retrieve information about the desired point of interest based on the direction of the user gesture received from the gesture capture device and the location and orientation of the vehicle received from the navigation device. The system further includes a display device coupled to the processing module and configured to display the information about the desired point of interest.

### TECHNICAL FIELD

The following description relates generally to information systems and methods, and more particularly to in-vehicle, gesture actuated point of interest information system and methods.

### BACKGROUND

Mobile, in-vehicle information systems, such as navigation information systems, have become commonplace in vehicles such as automobiles, trucks, sport utility vehicles, etc. The navigation information systems typically use a GPS navigation device to locate the vehicle of a user. The system may then display a map of the user's location on a display screen. Some systems additionally provide directions for the user based on an intended destination. Depending on the system, the user may also interact with the navigation information system to update the user's position and/or intended destination, typically by entering data on a touch-screen or keyboard associated with the display screen.

Conventional in-vehicle information systems such as navigation information systems generally only provide location and/or direction information. It would therefore be desirable to provide an in-vehicle information system with a more intuitive mechanism for inputting information that reduces driver distraction, as well as provides additional types of information. Other desirable features and characteristics will become apparent from the following detailed description and the appended claims, taken in conjunction with the accompanying drawings and the foregoing technical field and background.

### BRIEF SUMMARY

In accordance with an exemplary embodiment, an information system for providing point of interest information to a user in a vehicle is provided. The system includes a gesture capture device configured to capture data associated with a user gesture, the user gesture having a direction indicating a desired point of interest. The system further includes a navigation device configured to provide a location and orientation associated with the vehicle and a processing module coupled to the gesture capture device and the navigation device. The processing module is configured to retrieve information about the desired point of interest based on the direction of the user gesture received from the gesture capture device and the location and orientation of the vehicle received from the navigation device. The system further includes a display device coupled to the processing module and configured to display the information about the desired point of interest.

In accordance with another exemplary embodiment, a method for providing point of interest information to a user in a vehicle includes capturing data associated with a user gesture, the user gesture having a direction indicating a desired point of interest; receiving location and orientation of the vehicle from a navigation device; retrieving information about the desired point of interest based on the direction of the user gesture and the location and orientation of the vehicle received from the navigation device; and providing the information about the desired point of interest to the user.

### DESCRIPTION OF THE DRAWINGS

The present invention will hereinafter be described in conjunction with the following drawing figures, wherein like numerals denote like elements, and:

FIG. 1 is a block diagram of a gesture actuated point of interest information system for use in a vehicle in accordance with an exemplary embodiment;

FIG. 2 is a plan view of a vehicle utilizing the information system in accordance with an exemplary embodiment;

FIG. 3 is a flowchart of an exemplary gesture actuated point of interest information method in accordance with an exemplary embodiment.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

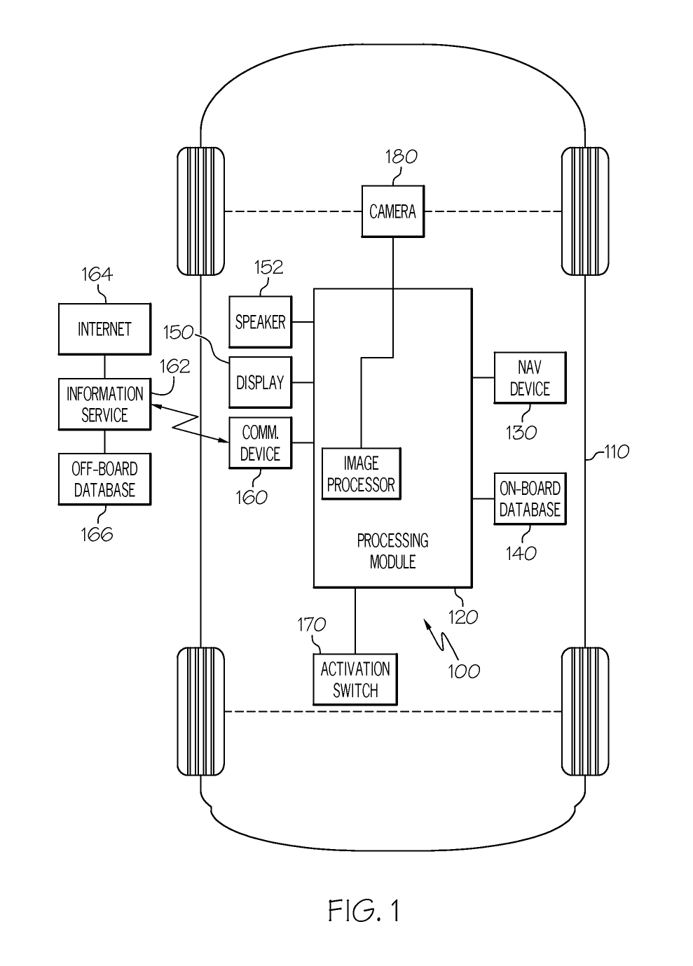

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment. It should also be understood that FIGS. 1-3 are merely illustrative and may not be drawn to scale.

FIG. 1 is a block diagram of a gesture actuated point of interest information system 100 in accordance with an exemplary embodiment. As will be described in further detail below, the information system 100 generally identifies a point of interest based on a user's gestures and provides information to the user associated with the desired point of interest. In one embodiment, the information system 100 is associated with a vehicle 110, including an automobile, truck, sport utility vehicle, aircraft, or watercraft.

As will be discussed in further detail below, the information system 100 includes a processing module 120 having an image processor 122. The information system 100 further includes a gesture capture device, such as a camera 180 coupled to the image processor 122. An activation switch 170, navigation device 130, and on-board database 140 are each coupled to the processing module 120. Output devices, such as a display device 150 and speaker 152, are also coupled to the processing module 120. The information system 100 further includes a communications device 160 to interact with an off-board information service 162 that communicates with the internet 164 and an off-board database 166.

In one exemplary embodiment, the information system 100 may be activated by the activation switch 170. The activation switch 170 may be a button such that the user can manually activate the information system 100. In an alternate exemplary embodiment, the activation switch 170 may include a microphone and audio processor that responds to a voice command.

As noted above, the information system 100 includes the gesture capture device, which in this exemplary embodiment is the camera 180 having a field-of-vision within the interior of the vehicle 110 suitable for sampling or monitoring gestures by the user. In one embodiment, the user may be a driver of the vehicle 110 and the field-of-vision may be in the area around the driver's seat. In particular, the camera 180 may be mounted on a dashboard to collect image data associated with the user gesture. In one embodiment, the gesture can be a hand and/or arm signal in a particular direction, such as the user pointing at a point of interest from the interior of the vehicle 110. The point of interest may be, for example, a landmark, a building, a place of historical interest, or a commercial establishment about which the user desires information.

In some embodiments, additional cameras may be provided to increase the field-of-vision and/or accuracy recognition of user gestures. For example, one or more cameras 180 may be positioned within the vehicle 110 to collect image data from a front seat or back seat passengers. Also, in some embodiments, a direct line-of-sight between camera 180 and the user is not required since optical transmission may be accomplished through a combination of lenses and/or mirrors. Thus, camera 180 may be situated at other convenient locations. In one alternate exemplary embodiment, the camera 180 forms part of the activation switch 170 to capture a predetermined activation gesture that is recognized by the information system 100.

The camera 180 provides the image data associated with the user gesture to the image processor 122 of the processing module 120. In general, the processing module 120, including the image processor 122, may be implemented with any suitable computing component, including processors, memory, communication buses, and associated software. In particular, the image processor 122 processes the optical gesture data and determines the direction in which the user is pointing. The image processor 122 can recognize the direction of the gesture using, for example, pattern recognition in which digitized characteristics of the image are matched with known patterns in a database to determine direction. In one exemplary embodiment, the camera 180 is a plan view camera instead of a front mounted, rearward looking camera that recognizes the angle of the gesture relative to the vehicle 110. Further embodiments may use a front-mounted, rearward looking 3D camera system or multiple cameras to determine the trajectory of the gesture.

In addition to direction, the system 100 may additionally recognize other characteristics of the gesture. These characteristics may be used to improve the accuracy of the system 100 and/or provide additional information to the user. For example, the number of arm casts, duration of gesture, length of arm, or elevation angle of gesture can be recognized by the system 100 to further specify the point of interest. For example, these characteristics can be correlated to estimated or perceived distance of the vehicle 100 to the point of interest. As one example, a single cast gesture may indicate to the system 100 that the user is gesturing to a relatively close point of interest, while a double cast gesture may indicate to the system 100 that the user is gesturing to a relatively distant point of interest. As another example, a positive elevation angle of gesture indicates a point of interest higher than the vehicle, such as a city skyline, while a negative elevation angle indicates a point of interest lower than the vehicle, such as a river underneath a bridge.

In further embodiments, gestures by the user may be recognized by the information system 100 without the camera 180. For example, a pointing implement, such as a wand, may be used by the user to indicate the desired point of interest. In this case, a sensor may be provided to determine the direction in which the wand is pointed. In other embodiments, the user can indicate the direction of the desired point of interest with a voice command. In these embodiments, the system may include a microphone and audio processor for recognizing the voice command.

The information system 100 further includes the navigation device 130 that provides the location and orientation of the vehicle 110. The navigation device 130 typically uses a GPS (global positioning system) device to acquire position data, such as the longitude and latitude of the vehicle 110. The navigation device 130 may also include a compass to determine the orientation of the vehicle 110, i.e., the direction in which the vehicle is pointed. Additional location and orientation may be provided using sensors associated with the drive train, gyroscopes, and accelerometers.

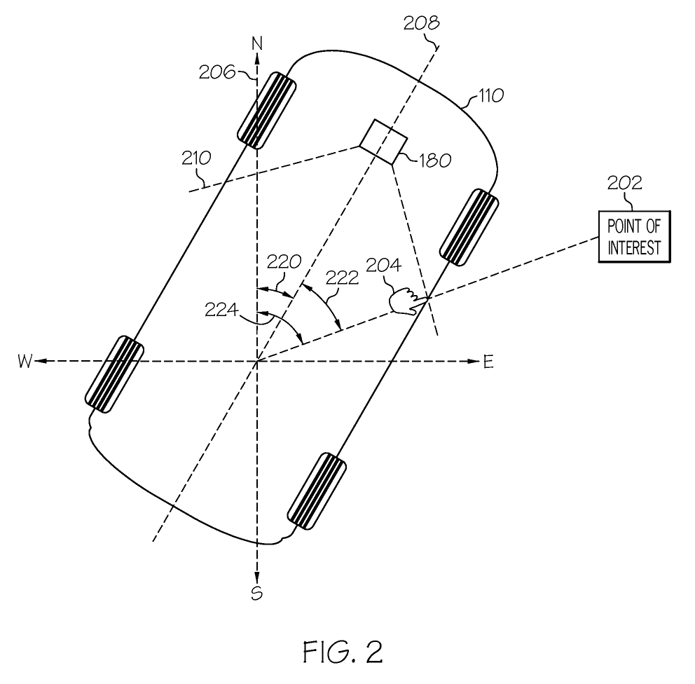

The navigation device 130 provides the location and orientation data to the processing module 120. Based on this data, as well as the gesture direction data, the processing module 120 can determine the absolute direction and location at which the user is gesturing. The processing module 120 then identifies the point of interest at which the user is gesturing based on data retrieved from the on-board database 140. The determination of the point of the interest is discussed in greater detail below in reference to FIG. 2.

In one embodiment, the processing module 120 will identify the most likely point of interest from all potential points of interest in the database 140 based on the location, orientation, and gesture direction. In addition to the location, orientation, and gesture direction, the characteristics used to determine the most likely point of interest may include such factors as the distance from the location to the potential point of interest, the size of the potential point of interest, desired point of interest category, and/or the popularity of the potential point of interest, for example, as determined by guide books, visitors, tourism rankings, etc. In some embodiments, the processing module 120 may provide a list of points of interest for selection by the user, and the user may select the desired point of interest from the list, for example, using a manual input, a voice command, and/or an additional gesture. In further embodiments, a camera pointed outside of the vehicle may also be used to identify the point of interest.

The processing module 120 then provides information data associated with the desired point of interest to the output devices, such as display device 150 or speaker 152. The display device 150 may be a screen that provides visual information about the point of interest while the speaker 152 may provide audio information about the point of interest. In one embodiment, the point of interest information includes the identity of the desired point of interest. In other embodiments, additional information can be provided, including hours of operation, contact information, historical information, address, admission availability, prices, directions, and other facts associated with the desired point of interest that may be of interest to the user. Additionally, in one embodiment, the system 100 may perform automated operations, such as hands-free dialing, acquiring reservations, or advance ticket purchases. The system 100 may additionally perform these automated operations in response to a prompted user request.

In one exemplary embodiment, the processing module 120 can provide the location, orientation, and gesture direction to the communication device 160 that wirelessly interfaces with an off-board information service 162 to retrieve identification and other types of point of interest information via the internet 164 and/or off-board database 166. This information may then be provided to the user via the display device 150 or speaker 152. In this embodiment, the on-board database 140 may or may not be omitted.

Referring briefly to FIG. 2, the vehicle 110 and camera 180 are shown to explain the identification of the point of interest in greater detail. In the example of FIG. 2, a user in the vehicle 110 is gesturing at a desired point of interest 202.

As stated above, the navigation device 130 (FIG. 1) can determine the orientation of the vehicle 110 using, for example, a compass. In the example shown in FIG. 2, the vehicle 110 has an orientation of about 30° relative to true North (e.g., angle 220), as shown in the compass rose 206 and vehicle axis 208. As also discussed above, the camera 180 has a field of view 210 that captures the direction vector of the gesture 204 of the user. In the example shown in FIG. 2, the direction vector of the gesture 204 is about 40° relative to the orientation of the vehicle 110 (e.g., angle 222), which results in the gesture 204 having an angle of about 70° relative to true North (e.g., angle 224). Accordingly, this information, along with the location of the vehicle 110, enables the processing module 120 (FIG. 1) to identify the point of interest 202 from a listing of the points of interest in the database 140 (FIG. 1).

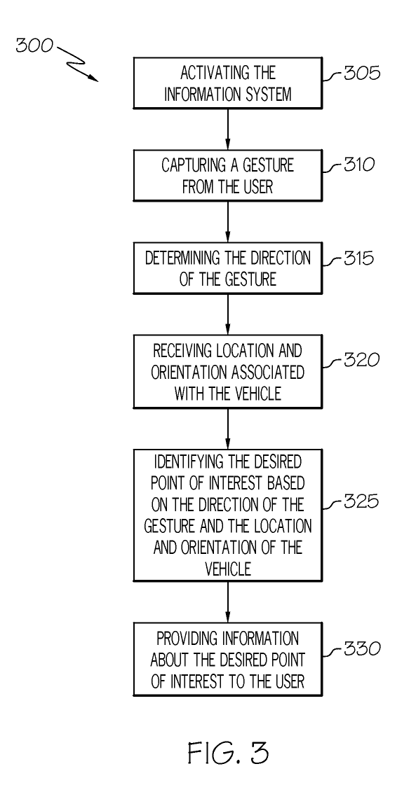

FIG. 3 is a flowchart of an exemplary method 300 for providing point of interest information to a user in a vehicle. Reference is additionally made to FIG. 1. In a step 305, the information system 100 is activated (i.e. “awake”) by the activation switch 170. In a step 310, the information system 100 captures a gesture from the user, such as a hand gesture, that points in a direction to a point of interest about which the user desires information. In one embodiment, the gesture is captured with a camera 180. In a step 315, the information system 100 determines a direction vector indicated by the gesture. As noted above, the system 100 determines the direction vector from an image captured by the camera 180 using, for example, pattern recognition or other mechanisms.

In a step 320, the information system 100 receives or determines the location and orientation of the vehicle 110, such as for example, with a navigation device 130. In a step 325, the information system 100 identifies the identity of the desired point of interest based on the direction of the gesture, as well as the location and orientation of the vehicle 110. In a step 330, the information system 100 then provides the identity of the desired point of interest to the user, typically via the speaker 152 and/or display device 150. Additional information associated may also be provided to the user.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. An information system for providing point of interest information to a user in a vehicle, the system comprising:
a gesture capture device configured to capture data associated with a user gesture, the user gesture having a direction indicating a desired point of interest;
a navigation device configured to provide a location and orientation associated with the vehicle;
a processing module coupled to the gesture capture device and the navigation device, the processing module configured to retrieve information about the desired point of interest based on the direction of the user gesture received from the gesture capture device and the location and orientation of the vehicle received from the navigation device; and
a display device coupled to the processing module and configured to display the information about the desired point of interest.

2. The information system of claim 1, wherein the gesture capture device comprises a camera that captures optical data associated with the user gesture.

3. The information system of claim 1, wherein the user gesture is a hand signal.

4. The information system of claim 1, further comprising a point of interest information database coupled to the processing module, the point of interest database comprising information associated with a plurality of points of interest, including the desired point of interest.

5. The information system of claim 1, wherein the processing module includes an optical processor configured to determine the direction of the user gesture.

6. The information system of claim 1, further comprising a communication system coupled to the processing module and configured retrieve the information associated with the desired point of interest from an off-board database.

7. The information system of claim 1, further comprising an audio device coupled to the processing module and configured to provide audio information to the user about the desired point of interest.

8. The information system of claim 1, wherein the processing module is configured to activate the system based on an audio signal.

9. The information system of claim 8 wherein the processing module is configured to activate the system based on a visual signal.

10. A method of providing point of interest information to a user in a vehicle, the method comprising:
capturing data associated with a user gesture, the user gesture having a direction indicating a desired point of interest;
receiving location and orientation of the vehicle from a navigation device;
retrieving information about the desired point of interest based on the direction of the user gesture and the location and orientation of the vehicle received from the navigation device; and
providing the information about the desired point of interest to the user.

11. The method of claim 10, wherein the providing step including displaying visual information about the desired point of interest.

12. The method of claim 10, wherein the providing step including providing audio information about the desired point of interest.

13. The method of claim 10, wherein the capturing data step includes capturing optical data with a camera.

14. The method of claim 10, wherein the capturing data step includes capturing a gesture that includes a hand signal.

15. The method of claim 10, wherein the retrieving step includes retrieving the information from an on-board point of interest information database.

16. The method of claim 10, wherein the retrieving step includes retrieving the information from an off-board point of interest information database.

17. The method of claim 10, further comprising activating the capturing step with an audio signal from the user.

18. The method of claim 10, further comprising activating the capturing step with a visual signal from the user.

19. The method of claim 10, wherein the providing step includes providing at least one of hours of operation, historical information, or directions associated with the desired point of interest.

20. An information system for providing point of interest information to a user in a vehicle, the system comprising:
a camera configured to capture optical data associated with a user gesture, the user gesture comprising a hand gesture with a direction pointing to a desired point of interest;
a navigation device configured to provide a location and orientation associated with the vehicle;
a point of interest information database comprising information associated with a plurality of points of interest, including the desired point of interest;
a processing module coupled to the gesture capture device, the navigation device, and the point of interest database,
the processing module configured to retrieve information about the desired point of interest from the point of interest database based on the direction of the user gesture received from the gesture capture device and the location and orientation of the vehicle received from the navigation device; and
a display device coupled to the processing module and configured to display the information about the desired point of interest.
